(19) United States
(12) Patent Application Publication
(10) Pub. No.: US 2009/0118110 A1
(43) Pub. Date: May 7, 2009

(54) Flexible Vase With Integral Label and a Method for Its Manufacture

(76) Inventors: Tzvi Nachumzon, Ramat Gan (IL); Chagai Strauss, Tel Aviv (IL); Eythan Nordman, Tel Aviv (IL)

Correspondence Address: THE NATH LAW GROUP, 112 South West Street, Alexandria, VA, 22314, US

(21) Appl. No.: 11/992,943

(22) PCT Filed: Oct. 3, 2006
(86) PCT No.: PCT/IL2006/001147

§ 371 Date: Apr. 1, 2008

(30) Foreign Application Priority Data
Oct. 2, 2005 (IL) 171242

(51) Int. Cl. B31B 1/00; B29D 22/00; B32B 27/36; G09F 3/00; B32B 27/32; B65D 85/50

(52) U.S. Cl. 493/52; 428/34.1; 428/35.7; 40/310; 156/218; 47/41.01

(57) ABSTRACT

The present invention provides an article of manufacture formed from a sheet material. The article has a collapsed vase portion and a label portion integral with the vase portion. The vase portion and the label portion have a common boundary, and when the label portion is detached from the vase portion is detached from the vase portion, the vase portion forms a flexible vase. In a preferred embodiment, the boundary is a weakened region in the sheet material, so that the label portion may be detached from the vase portion by tearing the label portion off from the vase portion along the weakened boundary. The invention also provides a method for manufacturing the article of manufacture of the invention, as well as a method for using the article of manufacture.

### FIELD OF THE INVENTION

This invention relates to vases, and more particularly to flexible vases.

### BACKGROUND OF THE INVENTION

Flower vases made from glass or porcelain are fragile, relatively heavy and occupy a relatively large volume. Flexible vases are also known that are made from a pliable sheet material. These vases are manufactured and sold in a flat, collapsed form and expand into a three dimensional shape upon introduction of water into the vase. When the vase is not in use it may be collapsed back into its flat form and stored for future usage. Exemplary prior art flexible vases are disclosed in U.S. Pat. No. 5,572,826 and U.S. Pat. No. 6,543,183, and US patent application publication 2004/0187382.

### SUMMARY OF THE INVENTION

In its first aspect, the present invention provides an article of manufacture comprising a collapsed flexible vase portion and a label portion integral with the vase. The article of manufacture is made from a sheet material that may be, for example, a polymeric material or a metal foil, such as aluminum foil. In a preferred embodiment of the invention, the article of manufacture is formed from a layer of polyester laminated to a layer of polyethylene. The vase portion and the label portion have a common boundary. In one preferred embodiment, the common boundary is a weakened region in the material of the article, so that the label portion may be manually detached from the vase portion. In another embodiment, the boundary is not weakened. In this case, the label portion may be detached from the vase portion by cutting along the boundary with a blade or pair of scissors. The boundary may be indicated, for example, by a printed line or curve in or order to guide the cutting at the boundary. After detachment of the label portion form the vase portion, the vase portion forms a flexible vase that may be filled with water and flowers may then be placed into the vase.

The label portion may be a top portion or any other portion, including sides and bottom portions. According to an embodiment of the invention, the article of manufacture may comprise more then one integrated though detachable label portions.

The label portion may be completely devoid of any printing. Alternatively, the label region may have printed on it information of interest to prospective buyers such as a picture of the vase in use, the name and logo of the manufacturer, price, barcode and user instructions. By providing this information on the integral label, the need for providing packaging for the article of manufacture carrying this information is obviated. The label portion may also have a greeting or salutation printed on it, or a space may be provided on the label portion to allow a personal greeting or salutation to be added to the label portion by a sender of the article of manufacture to a recipient.

In its second aspect, the invention provides a method of manufacturing an article of manufacture of the invention. In accordance with this aspect of the invention, an article of manufacture is formed from a sheet material having a vase portion and a label portion integral with the vase portion, wherein the vase portion and the label portion have a common boundary. In a preferred embodiment of this aspect of the invention, the boundary between the vase and label portions is then formed by weakening the article material along this boundary. The boundary between the label portion and the vase portion of the article of manufacture may be weakened, for example, by introducing perforations or a shallow groove along the boundary.

In its third aspect, the invention provides a method for using the article of manufacture of the invention. The method comprises detaching the label portion from the vase portion.

This, in its first aspect, the present invention provides an article of manufacture formed from a sheet material, the article having a collapsed vase portion and a label portion integral with the vase portion, the vase portion and the label portion having a common boundary, the vase portion forming a flexible vase when the label portion is detached from the vase portion.

In its second aspect, the invention provides a method for manufacturing an article of manufacture having a collapsed vase portion and an integral label portion, the vase portion forming a flexible vase when the label portion is detached from the vase portion, the method comprising:
(a) forming a sheet material into an article having a collapsed vase portion and an integral label portion, the vase portion forming a flexible vase when the label portion is detached from the vase portion, and
(b) forming a boundary between the vase and label portions.

In its third aspect, the invention provides a method for using an article of manufacture formed from a sheet material, the article having a collapsed vase portion and a label portion integral with the vase portion, the vase portion and the label portion having a common boundary, and the vase portion forming a flexible vase when the label portion is detached from the vase portion, the method comprising:

(a) detaching the label portion from the vase portion.

### BRIEF DESCRIPTION OF THE DRAWINGS

In order to understand the invention and to see how it may be carried out in practice, an embodiment will now be described, by way of a non-limiting example only, with reference to the accompanying drawings, in which:

FIG. 1 shows an article of manufacture having a vase portion and an integral label portion in accordance with one embodiment of the invention;

FIG. 2 shows a sectional view of the article of manufacture of FIG. 1;

FIG. 3 shows use of the article of manufacture of FIGS. 1 and 2; and

FIG. 4 shows a method for manufacturing the article of manufacture of the invention in accordance with one embodiment of this aspect of the invention.

### DETAILED DESCRIPTION OF EXEMPLARY EMBODIMENTS

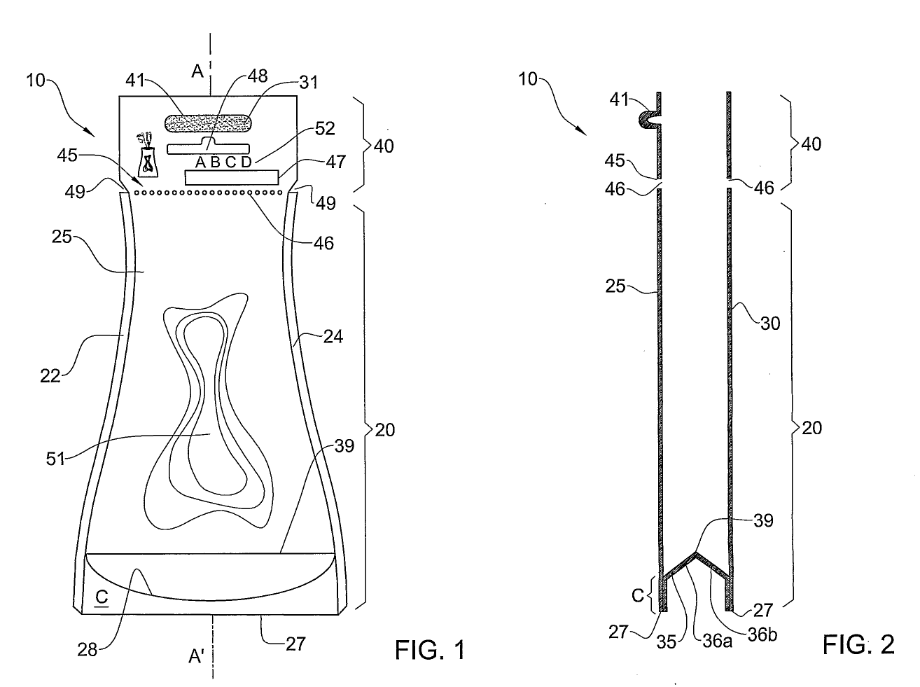

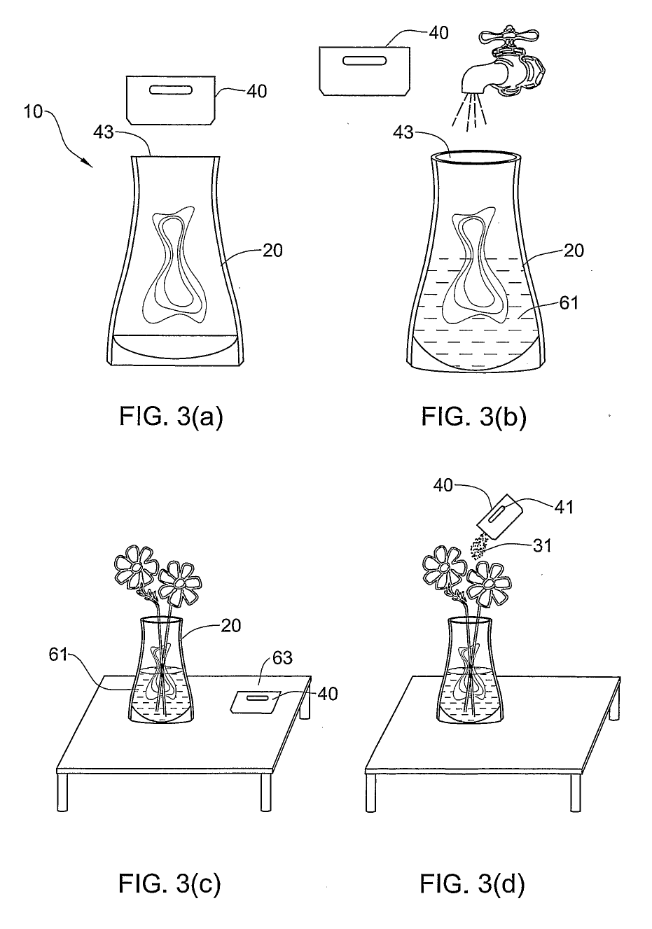

FIGS. 1 and 2 show an article of manufacture, generally indicated by 10, in accordance with one embodiment of this aspect of the invention. The article of manufacture 10 is shown in FIGS. 1 and 2 in a collapsed state of the article of manufacture. The article of manufacture 10 is shown in a front view in FIG. 1 and in a sectional view along an axis AA′ in FIG. 2. As best seen in FIG. 2, the article of manufacture 10 comprises a front sheet 25 and a rear sheet 30, and a bottom sheet 35. The bottom sheet 35 is folded in half along a crease 39 so as to form folded portions 36a and 36b. For the sake of clarity, the article of manufacture 10 is shown in FIG. 2 in a spaced apart arrangement, while in the collapsed state shown in FIGS. 1 and 2, the front sheet 25 and the rear sheet 30 are pressed against one another. In a preferred embodiment of the invention, the front and rear sheets are formed from a polymeric sheet material. In a most preferred embodiment, the front and rear sheets are formed from a laminate comprising a layer of polyester and a layer of polyethylene.

In accordance with the invention, the article of manufacture 10 includes a flexible vase portion 20 and an integral label portion 40. The vase portion 20 and the label portion 40 have a common boundary 45. The boundary 45 is a weakened region formed in the front sheet 25 and the rear sheet 30. For example, the boundary 45 may be formed by introducing perforations 46 into one or both of the front and rear sheets. The introduction of such perforations 46 may by accomplished using laser radiation, as is well known in the art. Alternatively, the boundary 45 may be formed by introducing a shallow groove in the outer exposed surface (not shown). The weakened boundary 45 allows the label portion 40 to be manually detached from the vase portion 20. Detachment of the label portion 40 from the vase portion 40 is facilitated by notches 49 at the ends of the boundary 45.

It is to be noted that the gap between the sheets 25 and 30 noticed in FIG. 2 is for clarification purposes only and that in reality this gap does not exists as long as the label portion is attached thereto, but only after detachment.

The front sheet 25 and the rear sheet 30 are bonded together in a fluid tight bond along lateral regions 22 and 24 of the front and rear sheets. The width of the fused regions 22 and 24 may be, for example, 0.5 cm. Throughout a region C between a bottom edge 27 of the vase portion 20 and the vase bottom 28, the front sheet 25 is bonded to the folded portion 36a of the bottom sheet 35, in a fluid tight bond and the rear sheet 30 is fused to the folded portion 36b of the bottom sheet 35 in a fluid tight bond.

A decorative pattern 51 may be printed on or inside one or both of the front sheet 25 and the rear sheet 30 in the region of the vase portion 20. One or both of the front sheet 25 and the rear sheet 30 may have printed on them, or inside of them, in the label region 41, information 52 of interest to prospective buyers such as a picture of the vase in use, the name and logo of the manufacturer, price, barcode, and user instructions. The label portion 40 may also have a greeting or salutation printed on it, or a space 47 may be provided on the label portion 40 to allow a personal greeting or salutation to be added to the label portion 40 by a sender of the article of manufacture 10 to a recipient.

The label portion 40 may be provided with an aperture 48 to allow the article of manufacture 10 to be hung on a display rack in a store. The label portion 40 may also be provided with a blister 41 formed between the front sheet 25 and the rear sheet 30 containing one or more promotional items, such as a fertilizer 31 to be added to the water in the vase, when the vase is in use, as explained below.

In the embodiment of FIGS. 1 and 2, the label portion 40 is located at the top of the article of manufacture 10, above the vase portion 20 when the article of manufacture is held in an upright position. This is by way of example only, and the label and vase portions may be arranged in the article of manufacture of the invention in any desired arrangement. For example, the label portion may be attached to the vase portion along a lateral edge of the vase portion (not shown) instead of the top edge, as shown in FIGS. 1 and 2. Also, the label portion 40 is shown in FIG. 1 as having a rectangular shape. This is also only by way of example, and the label portion may have any desired shape.

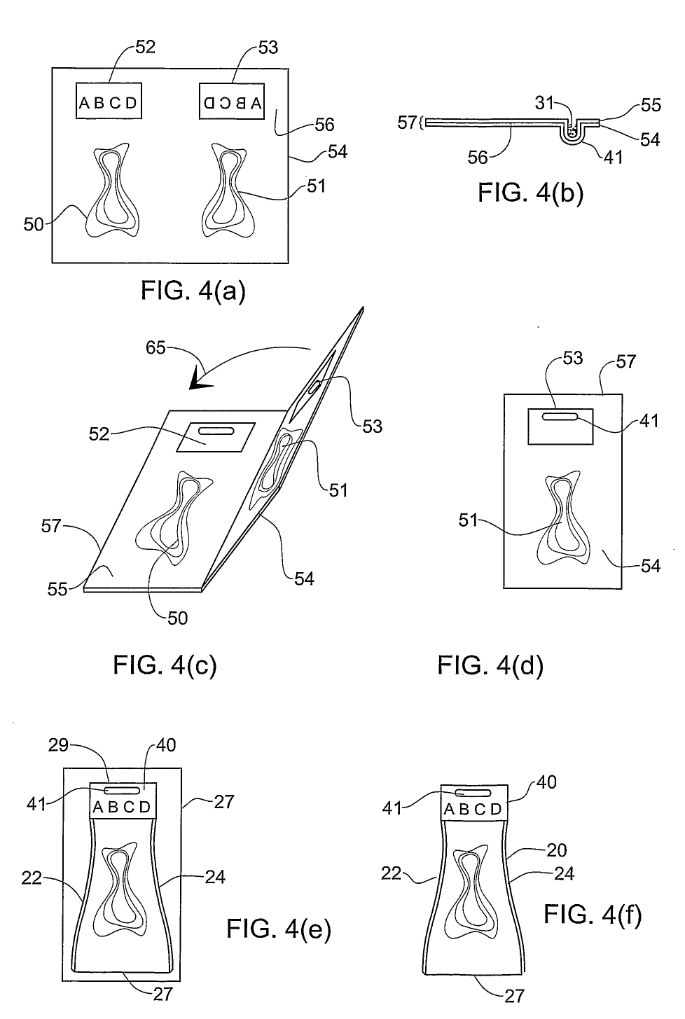

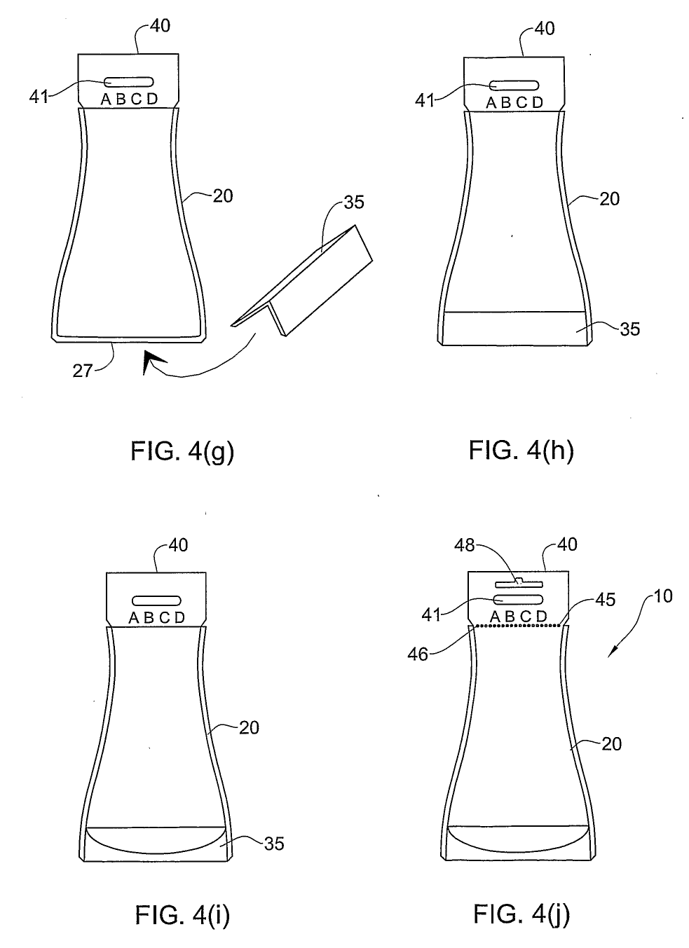

FIG. 3 shows use of the article of manufacture 10. In FIG. 3a, the label portion 40 is detached from the vase portion 20 by tearing the article of manufacture along the weakened boundary 45. Detachment of the label portion 40 from the vase portion 20 creates a mouth or opening 43 in the vase portion 20. The vase portion 20 is filled with a substance, such as water 61, through the mouth 43 (FIG. 3b). As the vase portion 20 fills with water, it acquires an expanded state in which it has the structure of a so-called “stand-up pouch” (also known as a “doypack”). Thus, as shown in FIG. 3c, after filling with water, the vase portion 20 stands stably on a surface 63 and flowers 62 may be introduced into the vase portion 20. The blister 41 in the label portion 40 may then be ruptured and the fertilizer 31 poured from the blister 41 into the water (FIG. 4d). The label portion 40 may then be discarded.

FIG. 4 shows a method of manufacturing an article of manufacture of the invention, in accordance with one preferred embodiment of this aspect of the invention. In FIG. 4a, a first design pattern 50, a second design pattern 51, a first label pattern 52 and a second label pattern 53 are printed on a surface 56 of a sheet 54 of polyester. The printing may be performed by any printing method such as a rota gravure method, a flexo printing method, etc. Then, as shown in FIG. 4b, the sheet 54 of polyester is laminated by heat bonding to a sheet 55 of polyethylene, with the printed surface 56 of the polyester sheet 54 in contact with the polyethylene sheet 55. In this way, a laminate 57 is formed in which the printing is sandwiched between the polyester and polyethylene sheets, and is thus protected from scratching and other types of damage.

At this time, the blister 41 may be formed in the laminate 57 and filled with any desired object or material, such as the fertilizer 31. The laminate 57 consisting of the polyester and polyethylene sheets 54 and 55 is folded as indicated by the arrow 65 (FIG. 4c), with the polyethylene layers 55 being in the interior of the folded laminate. In the folded laminate, the first and second design patterns 50 and 51 overlap, and the first and second label patterns overlap (FIG. 4d). In this folded configuration, the polyethylene sheet 55 is located in the interior of the folded laminate 57, and the polyester sheet is located on the exterior of the folded laminate 57.

The two layers of the folded laminate are now bonded together in the label portion 40 and the lateral edges 22 and 24 of the vase portion 20 (see FIG. 1) (FIG. 4e). The bonding is preferably performed by heat welding. The heat welding fuses the polyethylene layers of the front and rear sheets, but does not affect the polyester layer or the printing on the polyester layer. Then, as shown in FIG. 4f, excess material is trimmed from the folded laminate by cutting along the bonded edges 22 and 24 and along the bottom edge 27 (FIG. 1) of the article of manufacture 10. The front sheet 25 and the rear sheet 30 are thus formed. The bottom portion 35 is then folded along the crease 39 and is inserted between the front sheet 25 and the rear sheet 30 through the cut edge 27 and is positioned between the front and rear sheets adjacent to the cut edge 27, as shown in FIGS. 4g and h. The front and rear sheets are then fused together in the region C (FIG. 4i). The boundary 45 between the label portion 40 and the vase portion 20 is formed by weakening one or both of the front sheet 25 and the rear sheet 30 along the boundary 45, and cutting the notches 49. As explained above, weakening the boundary 45 may be accomplished by introducing perforations 46 along the boundary 45, or forming a groove along the boundary 45. Finally, the aperture is formed in the label region 40 (FIG. 4j).

In an alternative embodiment, the polyethylene layer is not printed in the label region. In this case, a paper or cardboard label may be stapled, glued, or otherwise attached to the label region 40.

1-28. (canceled)

29. An article of manufacture formed from a sheet material, the article having a collapsed vase portion and a label portion integral with the vase portion, the vase portion and the label portion having a common boundary, the vase portion forming a flexible vase when the label portion is detached from the vase portion.

30. The article of manufacture according to claim 29 wherein the sheet material is weakened in the boundary.

31. The article of manufacture according to claim 29 in which the boundary is indicated by a line or curve printed on the sheet material.

32. The article of manufacture according to claim 30 in which the boundary is weakened by perforations or a groove in the sheet material along the boundary.

33. The article of manufacture according to claim 29 wherein the sheet material is a polymeric material.

34. The article of manufacture according to claim 33 wherein the sheet material comprises one or both of polyester and polyethylene.

35. The article of manufacture according to claim 33 wherein the sheet material comprises a laminate comprising a layer of polyester and a layer of polyethylene.

36. The article of manufacture according to claim 29 comprising printing visible on an exposed surface of the article.

37. The article of manufacture according to claim 35 having printing between the polyester layer and the polyethylene layer.

38. The article of manufacture according to claim 36 comprising printing that is visible on an exposed surface of the label portion.

39. The article of manufacture according to claim 29 wherein the label portion comprises a blister containing one or more materials or objects.

40. The article of manufacture according to claim 29 comprising a front sheet and a rear sheet, the front and rear sheets being bonded together along one or more edges of the vase portion.

41. The article of manufacture according to claim 40 further comprising a bottom piece of sheet material joining the front and rear sheets.

42. A method for manufacturing an article of manufacture having a collapsed vase portion and an integral label portion, the vase portion forming a flexible vase when the label portion is detached from the vase portion, the method comprising:
(a) forming a sheet material into an article having a collapsed vase portion and an integral label portion, the vase portion forming a flexible vase when the label portion is detached from the vase portion, and
(b) forming a boundary between the vase and label portions.

43. The method according to claim 42 wherein the boundary is formed by printing a line or curve at the boundary.

44. The method according to claim 42 wherein the boundary is formed by weakening the sheet material along the boundary.

45. The method according to claim 44 wherein the boundary between the label portion and the vase portion is weakened by introducing perforations or a groove along the boundary.

46. The method according to claim 42 further comprising introducing printing in or on the sheet material, the printing being visible on an exposed surface of the article.

47. The method according to claim 42 further comprising forming a blister in the label portion.

48. The method according to claim 47 further comprising placing in the blister one or more materials or objects.

49. The method according to claim 42 comprising:
(a) printing on a surface of a sheet of polyester;
(b) laminating the printed surface of the polyester sheet to a sheet of polyethylene to form a laminate with printing between the polyester and polyethylene layers;
(c) folding the laminate to form a front sheet and a back sheet with the polyethylene layer in the interior of the folded laminate;
(d) bonding the front sheet to the back sheet along one or more edges of the vase portion;
(e) bonding the front sheet to the back sheet in at least a portion of the label portion; and
(f) weakening a boundary between the vase portion and the label portion in one or both of the front sheet and the back sheet.

50. The method according to claim 49 further comprising cutting the laminate along a bottom of the vase portion and bonding a bottom portion to the from and rear sheets.

51. The method according to claim 49 wherein the bonding is accomplished by heat welding of the polyethylene layer of the front sheet to the polyethylene layer of the rear sheet.

52. A method for using an article of manufacture formed from a sheet material, the article having a collapsed vase portion and a label portion integral with the vase portion, the vase portion and the label portion having a common boundary, and the vase portion forming a flexible vase when the label portion is detached from the vase portion, the method comprising:
(a) detaching the label portion from the vase portion.

53. The method according to claim 52 in which the sheet material is weakened and the label portion is detached from the vase portion by tearing.

54. The method according to claim 52 wherein the label portion is detached from the vase portion by cutting.

55. The method according to claim 52 further comprising filling the vase portion with a substance.

56. The method according to claim 55 wherein the substance is water.
